(19) United States
(12) Patent Application Publication
(10) Pub. No.: US 2016/0066096 A1
(43) Pub. Date: Mar. 3, 2016

(54) ACOUSTIC TRANSDUCER

(71) Applicant: SAMSUNG ELECTRO-MECHANICS CO., LTD., Suwon-si (KR)

(72) Inventors: Hwa Sun LEE, Suwon-si (KR); Jae Chang LEE, Suwon-si (KR); Jong Beom KIM, Suwon-si (KR); Byung Hun KIM, Suwon-si (KR)

(73) Assignee: SAMSUNG ELECTRO-MECHANICS CO., LTD., Suwon-si (KR)

(21) Appl. No.: 14/645,464

(22) Filed: Mar. 12, 2015

(30) Foreign Application Priority Data
Aug. 28, 2014 (KR) 10-2014-0113012

(51) Int. Cl. H04R 7/12

(52) U.S. Cl. CPC H04R 7/122; H04R 2499/11

(57) ABSTRACT

An acoustic transducer includes a substrate member provided with a plurality of holes formed therein through which sound waves are input, a vibration member including a first region and a second region provided at an edge of the first region and disposed to be parallel to the substrate member while having an interval therebetween, and a plurality of support members disposed along the edge of the first region.

### CROSS-REFERENCE TO RELATED APPLICATION

This application claims the priority and benefit of Korean Patent Application No. 10-2014-0113012 filed on Aug. 28, 2014, with the Korean Intellectual Property Office, the disclosure of which is incorporated herein by reference.

### BACKGROUND

The present disclosure relates to an acoustic transducer capable of improving acoustic sensitivity.

An acoustic transducer commonly mounted in portable terminals, and the like, and converts sound pressure or acoustic signals into electric signals. For example, such an acoustic transducer commonly includes a diaphragm that is configured to be vibrated by sound pressure.

However, according to the acoustic transducer having the above-mentioned structure, since the central portion of the diaphragm is vibrated by sound pressure while a peripheral portion of the diaphragm is not substantially vibrated, it is difficult to obtain a high degree of acoustic sensitivity therewith.

For reference, as the related art associated with the present disclosure, there is Patent Document 1.

### RELATED ART DOCUMENT

(Patent Document 1) JP2009-017578 A

### SUMMARY

An aspect of the present disclosure may provide an acoustic transducer having improved acoustic sensitivity.

According to an aspect of the present disclosure, an acoustic transducer may include a vibration member having an edge portion configured to be vibrated by sound pressure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a plan view of an acoustic transducer according to an exemplary embodiment in the present disclosure;

FIG. 2 is a cross-sectional view taken along the line A-A of the acoustic transducer shown in FIG. 1;

FIG. 3 is an enlarged view of the part B shown in FIG. 2;

FIG. 4 is an enlarged view of the part C shown in FIG. 2;

FIG. 5 is a cross-sectional view taken along the line D-D of the acoustic transducer shown in FIG. 2;

FIGS. 6 and 7 are cross-sectional views taken along the line A-A showing an operation state of the acoustic transducer shown in FIG. 1;

FIG. 8 is a plan view of a vibration member according to another exemplary embodiment in the present disclosure;

FIG. 9 is a plan view of an acoustic transducer according to another exemplary embodiment in the present disclosure;

FIG. 10 is a cross-sectional view taken along the line D-D of the acoustic transducer shown in FIG. 9;

FIG. 11 is a plan view of an acoustic transducer according to another exemplary embodiment in the present disclosure;

FIG. 12 is a cross-sectional view taken along the line D-D of the acoustic transducer shown in FIG. 11;

FIG. 13 is a cross-sectional view taken along the line A-A of the acoustic transducer according to another exemplary embodiment in the present disclosure; and

FIG. 14 is a cross-sectional view taken along the line A-A of the acoustic transducer according to another exemplary embodiment in the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

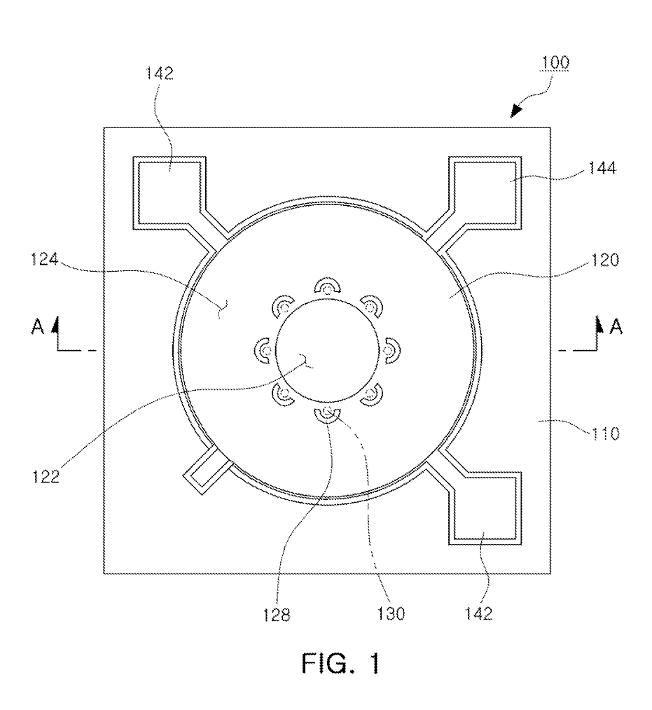

An acoustic transducer according to an exemplary embodiment in the present disclosure will be described with reference to FIG. 1.

An acoustic transducer 100 may include a substrate member 110, a vibration member 120, and a support member 130. Further, the acoustic transducer 100 may include a plurality of electrodes 142 and 144.

The substrate member 110 may be generally formed in a quadrangular shape. For example, the substrate member 110 may have a plan shape of a square. However, the plan shape of the substrate member 110 is not limited to the square. For example, the plan shape of the substrate member 110 may be modified to a circular shape, a polygonal shape, a rectangular shape, and the like.

The substrate member 110 may have the plurality of electrodes 142 and 144 formed thereon. For example, the substrate member 110 maybe provided with first electrodes 142, which are two, and a second electrode 144, which is a single. The first electrodes 142 may be extended from two corners to the center and may be widely formed generally in a circular shape at the central portion of the substrate member 110. The second electrode 144 may be extended from another corner of the substrate member 110 to the support member 130 and may be widely formed on an overall region of the vibration member 120 along the support member 130.

The vibration member 120 may be disposed while having a distance from the substrate member 110. For example, the vibration member 120 may be maintained at a distance that is not substantially in contact with the substrate member 110 by the support member 130. The vibration member 120 may be generally formed in a circular shape. However, a plan shape of the vibration member 120 is not limited to the circular shape. For example, the vibration member 120 may be formed in other shapes other than the circular shape.

The vibration member 120 may be classified into a first region 122 and a second region 124. For example, the central portion of the vibration member 120 may be the first region 122 and an edge of the vibration member 120 may be the second region 124. The first region 122 and the second region 124 may be classified by the support member 130. For example, an inside portion surrounded by a plurality of support members 130 may be defined as the first region 122, and outside portions of the plurality of support members 130 may be defined as the second region 124. The first region 122 and the second region 124 may be classified depending on whether or not the vibration member 120 is deformed. For example, a portion in which the deformation substantially hardly occurs by sound waves may be defined as the first region 122, and portions in which the deformation occurs by the sound waves may be defined as the second region 124. The second region 124 may have an area larger than that of the first region 122. For example, a size of the second region 124 in which the deformation substantially occurs by the sound waves may be larger than that of the first region 122. Therefore, the acoustic transducer 100 according to the present exemplary embodiment may obtain high acoustic sensitivity by the vibration member 120 having the same size.

The vibration member 120 may have a plurality of grooves 128 formed therein. The groove 128 maybe formed in a connection portion between the vibration member 120 and the support member 130. For example, the grooves 128 may be formed in a circular arc shape along a circumference of the support member 130. The grooves 128 formed as described above may allow the second regions 124 of the vibration member 120 to be smoothly vibrated by the sound waves. However, the grooves 128 having the shape described above are not necessarily formed in the vibration member 120. For example, the grooves 128 may be omitted or deformed depending on the shape of the vibration member 120.

The support member 130 may be formed to connect the substrate member 110 and the vibration member 120 to each other. For example, the support member 130 may be extended to be long from one surface of the substrate member 110 to one surface of the vibration member 120. The support members 130 may be disposed in a circular shape based on the first region 122. For example, eight support members 130 may be disposed along the edge of the first region 122 while having an interval therebetween.

Since the acoustic transducer 100 configured as described above has a shape which is substantially integrated based on the vibration member 120, it may be easily mounted in a small wireless terminal, or the like.

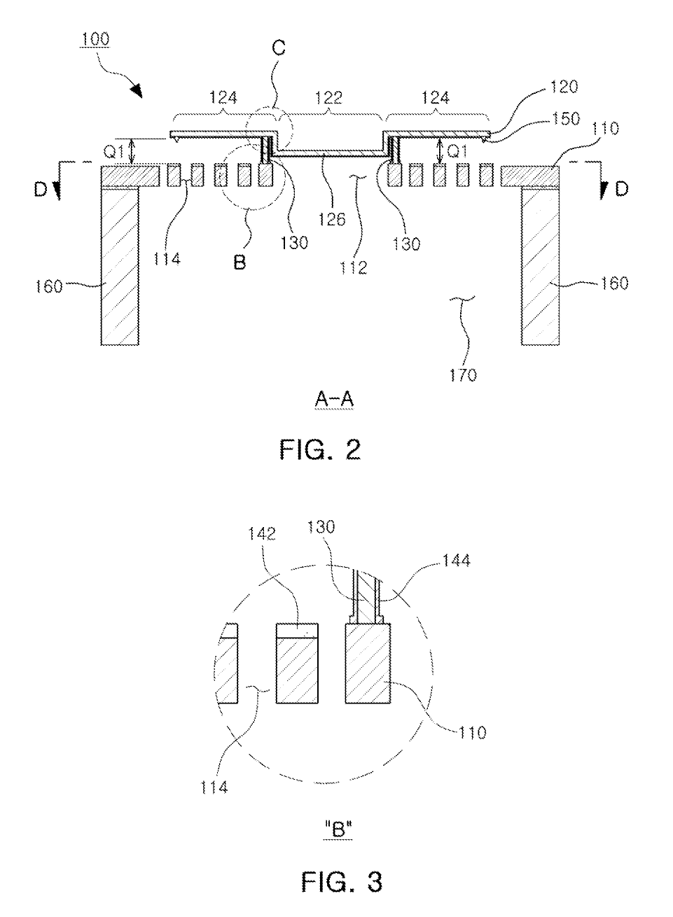

A structure of a cross section taken along the line A-A of the acoustic transducer will be described with reference to FIG. 2.

The acoustic transducer 100 may have a structure in which the substrate member 110 and the vibration member 120 are disposed while having a distance therebetween. For example, the substrate member 110 and the vibration member 120 may be disposed to be parallel to each other so as not to be in contact with each other by the support member 130.

The substrate member 110 may have a plurality of holes formed therein. For example, the substrate member 110 may have a first hole 112 and a second hole 114 formed therein. The first hole 112 may be formed at the central portion of the substrate member 110. For example, the first hole 112 may be formed at a portion facing the first region 122 of the vibration member 120. The second hole 114 may be formed at an edge portion of the substrate member 110. For example, the second hole 114 may be formed at a portion facing the second region 124 of the vibration member 120. The second hole 114 may be formed to have a size smaller than that of the first hole 112. For example, a total area of a plurality of second holes 114 may be smaller than an area of a first hole 112. However, a size relationship between the first hole 112 and the second hole 114 does not need to necessarily satisfy the above-mentioned relationship.

The vibration member 120 may include a protrusion part 126. For example, the first region 112 of the vibration member 120 may be the protrusion part 126 formed to be extended to the substrate member 110. The protrusion part 126 formed as described above may disperse the sound waves input through the first hole 112 in a direction of the second region 124. In addition, the protrusion part 126 may serve to increase restoring force of the second region 124.

The support member 110 and the vibration member 120 which are disposed as described above may have capacitance formed therebetween. For example, one surface (an upper surface based on FIG. 2) of the substrate member 110 and the second region 124 of the vibration member 120 may have first capacitance Q1 formed therebetween.

The acoustic transducer 100 may further include an insulation member 150. As an example, the insulation member 150 may be formed at both ends of the vibration member . However, the position of forming the insulation member 150 is not limited to both ends of the vibration member 120. As another example, the insulation member 150 may be formed on the substrate member 110.

The insulation member 150 configured as described above may block a contact between the substrate member 110 and the vibration member 120. Therefore, according to the present exemplary embodiment, a problem caused due to an electrical contact between the substrate member 110 and the vibration member 120 may be solved.

A pedestal member 160 may be formed on one side of the substrate member 110. For example, the pedestal member 160 may be formed so as to maintain the substrate member 110 at a predetermined height. However, there is no need to necessarily form the pedestal member 160 on one side of the substrate member 110. For example, the pedestal member 160 may be formed on a terminal apparatus having the acoustic transducer 100 mounted therein.

An acoustic input chamber 170 may be formed below the substrate member 110. For example, the acoustic input chamber 170 may be a space formed by the substrate member 110 and the pedestal member 160. The sound input chamber 170 may temporarily store sound that is input from the outside. For example, the sound input chamber 170 may form a back volume or a front volume required for sensing the sound.

A portion B of the acoustic transducer will be described with reference to FIG. 3.

The substrate member 110 may have an electrode formed thereon. For example, the substrate member 110 may have one or more electrodes formed thereon. As an example, in the substrate member 110, the first electrode 142 may be formed on a portion facing the second region 124 of the vibration member 120 and the second electrode 144 may be formed on a portion in which the support member is formed. The first electrode 142 and the second electrode 144 may have different polarities.

The support member 130 may have the second electrode 144 formed thereon. For example, the support member 130 may have the second electrode 144 formed therearound.

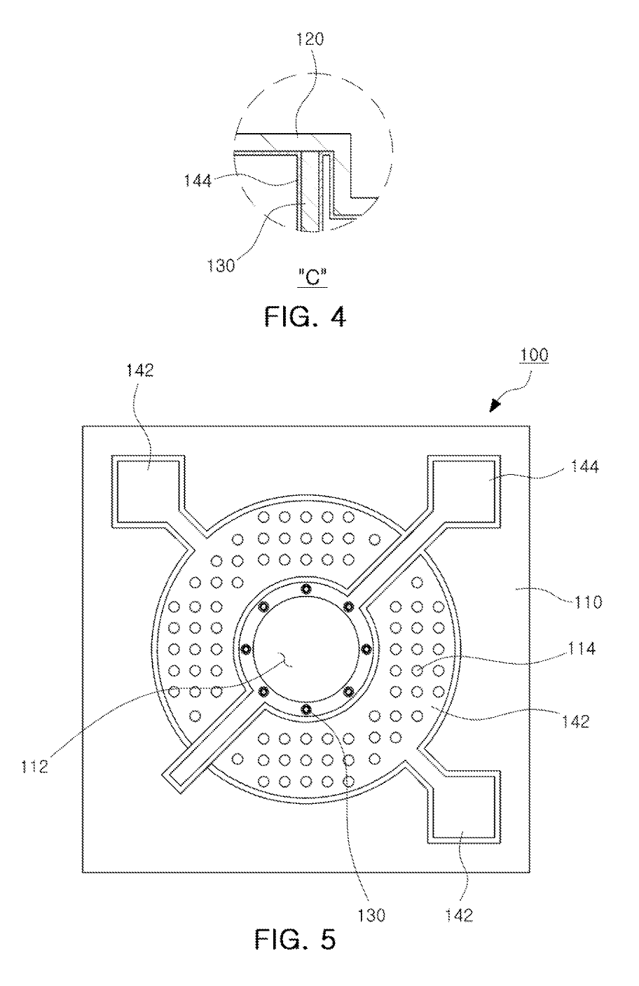

A portion C of the acoustic transducer will be described with reference to FIG. 4.

The vibration member 120 may have an electrode formed thereon. For example, the vibration member 120 may have the second electrode 144 formed on a bottom surface thereof. The second electrode 144 may be formed to be long along the support member 130. For example, the second electrode 144 may be formed to be wide along the overall bottom surface of the vibration member 120 and may be then formed to be extended to a downward direction along the support member 130. The second electrode 142 may have polarity different from that of the first electrode 142 as described above.

A structure of a cross section taken along the line D-D of the acoustic transducer will be described with reference to FIG. 5.

The acoustic transducer 100 may include a plurality of electrodes 142 and 144. For example, the first electrode 142 and the second electrode 144 may be formed on one surface of the substrate member 110, as shown in FIG. 5. The first electrode 142 may be formed in the substantially same shape as that of the second region 124 of the vibration member 120. For example, the first electrode 142 maybe formed on a portion which substantially faces the second region 124 of the vibration member 120 in the substrate member 110. The second electrode 144 may be formed so as to divide the first electrode into two regions. For example, the second electrode 144 may be formed to be long from a corner of one side of the substrate member 110 to a facing corner. The second electrode 144 may be formed so as to include a region in which the support members 130 are disposed. For example, one portion of the second electrode 144 may have a circular shape which is substantially similar to an arrangement shape of the support members 130.

The first electrode 142 and the second electrode 144 may be formed so as not to be in contact with each other. For example, the first electrode 142 and the second electrode 144 may have an insulating material formed therebetween. As another example, the first electrode and the second electrode 144 may be partitioned by the groove formed during an etching process of the substrate member 110.

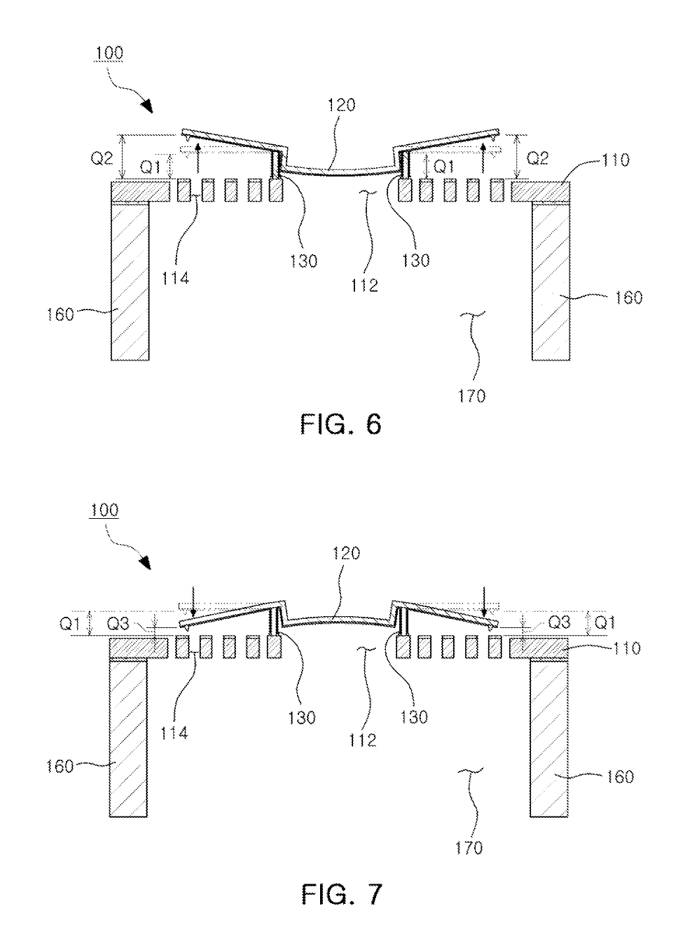

An operation state of the acoustic transducer will be described with reference to FIGS. 6 and 7.

The acoustic transducer 100 may be configured to be significantly deformed by the sound waves. For example, the acoustic transducer 100 may have the second region 124 having a relatively large area that is deformed in a vertical direction (a direction based on FIGS. 6 and 7) by the sound waves.

As an example, as shown in FIG. 6, in the case in which the sound waves is input from a lower portion of the substrate member 110 to an upper portion thereof, the second region 124 of the vibration member 120 may be bent in an upper direction (a direction based on FIG. 6). In this case, the substrate member 110 and the second region 124 may have second capacitance Q2, which is smaller than the first capacitance Q1, formed therebetween.

As another example, as shown in FIG. 7, the second region 124 of the vibration member 120 may be bent in a lower direction (a direction based on FIG. 7) by elastic restoring force of the vibration member 120. In this case, the substrate member 110 and the second region 124 may have third capacitance Q3, which is larger than the first capacitance Q1, formed therebetween.

The acoustic transducer 100 may convert deviation between the first capacitance Q1, and the second capacitance Q2 and third capacitance Q3 into an electrical signal, so as to sense the sound waves. Meanwhile, since the acoustic transducer 100 causes a change in capacitance as the second region 124 occupying a large area of the vibration member 120 is deformed, it may obtain improved sound wave sensitivity as compared to other acoustic transducers having the same size.

The protrusion part 126 may be configured to improve the elastic restoring force of the second region. For example, the protrusion part 126 may accumulate deformation energy by the sound waves while being deformed as shown in FIGS. 6 and 7, and may convert the accumulated energy into restoring energy of the vibration member 120.

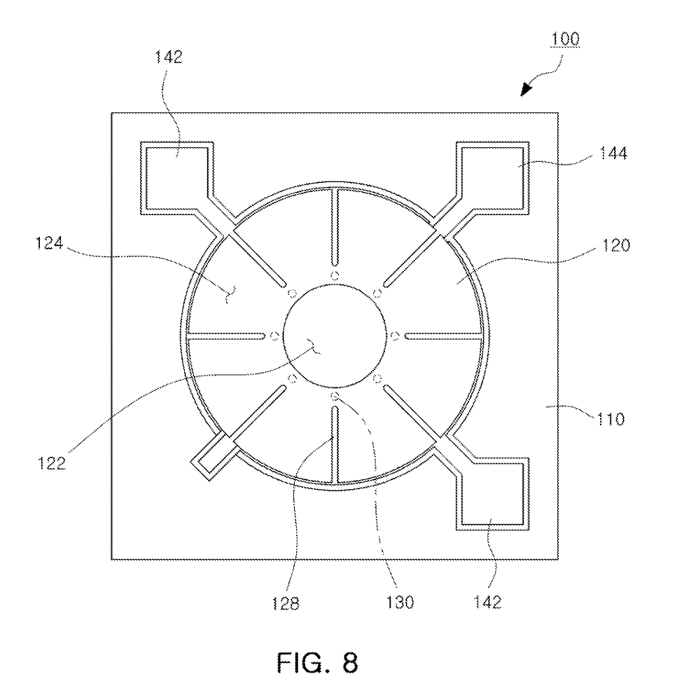

Another form of the vibration member will be described with reference to FIG. 8.

The vibration member 120 may be deformed as shown in FIG. 8. For example, the vibration member 120 may be provided with a plurality grooves formed therein and extended from the edge of the vibration member 120 to the first region. The above-mentioned grooves 128 may increase a degree of deformation of the vibration member 120, so as to improve the sound waves sensitivity.

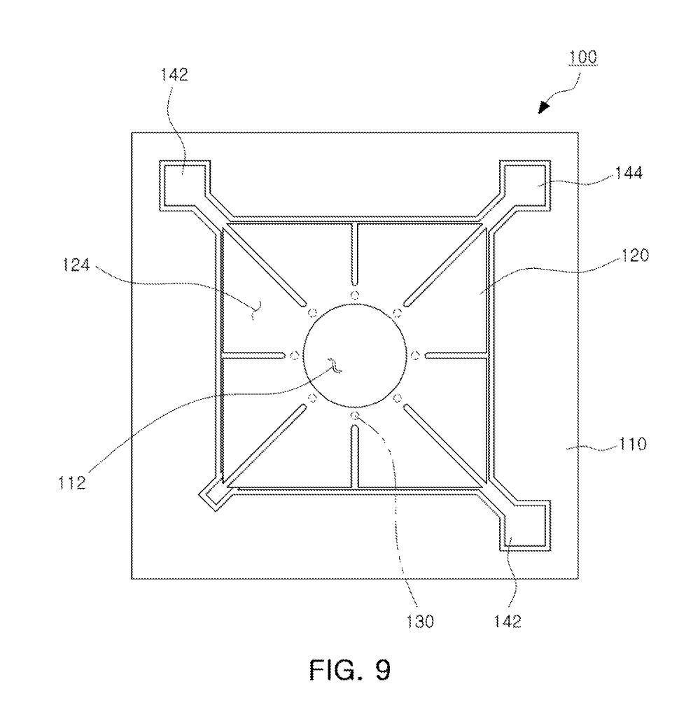

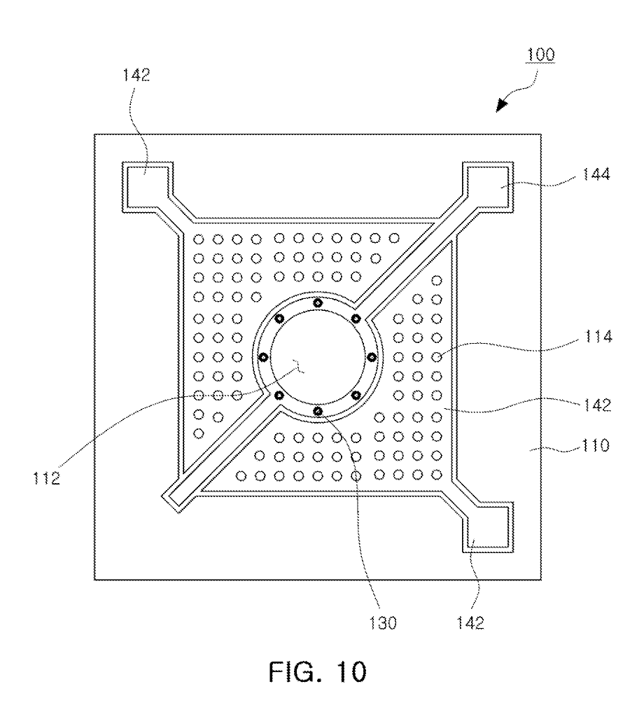

An acoustic transducer according to another exemplary embodiment in the present disclosure will be described with reference to FIGS. 9 and 10.

The acoustic transducer 100 according to the present exemplary embodiment may be distinguished from the acoustic transducer 100 according to an exemplary embodiment as described above in a plan shape of the vibration member 120. For example, the vibration member 120 may be formed in a square shape as shown in FIG. 9. The vibration member 120 may have a plurality of grooves 128 formed therein. As an example, the plurality of grooves 128 may be formed to be long from the respective sides of the vibration member 120 to the first region 122. As another example, the plurality of grooves 128 may be formed to be long from the respective corners of the vibration member 120 to the first region 122.

The substrate member 110 may be provided with the first electrode 142 having a shape substantially equal or similar to that of the vibration member 120. For example, the first electrode 142 may be formed in a quadrangular shape, similar to the vibration member 120. However, the shape of the first electrode 142 is not limited to the above-mentioned shape. For example, the first electrode 142 maybe formed to be larger than the vibration member 120.

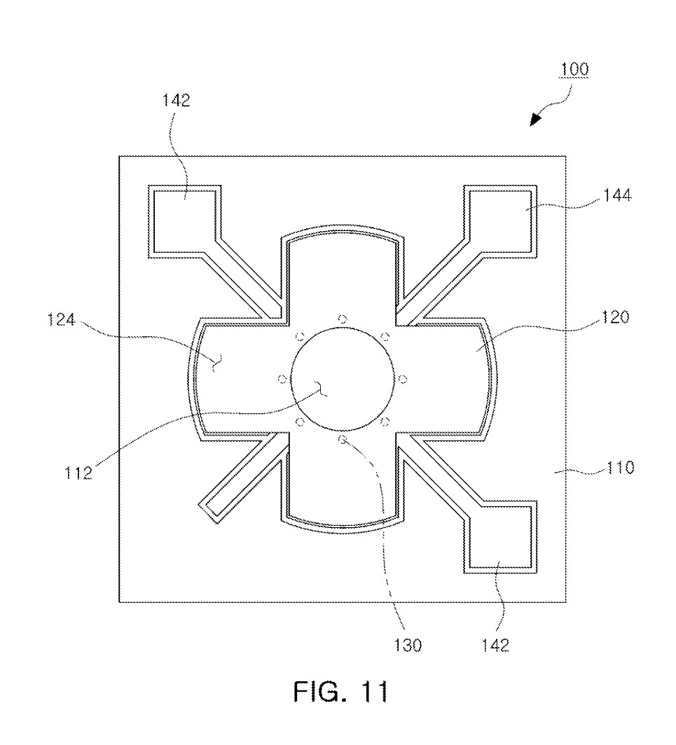

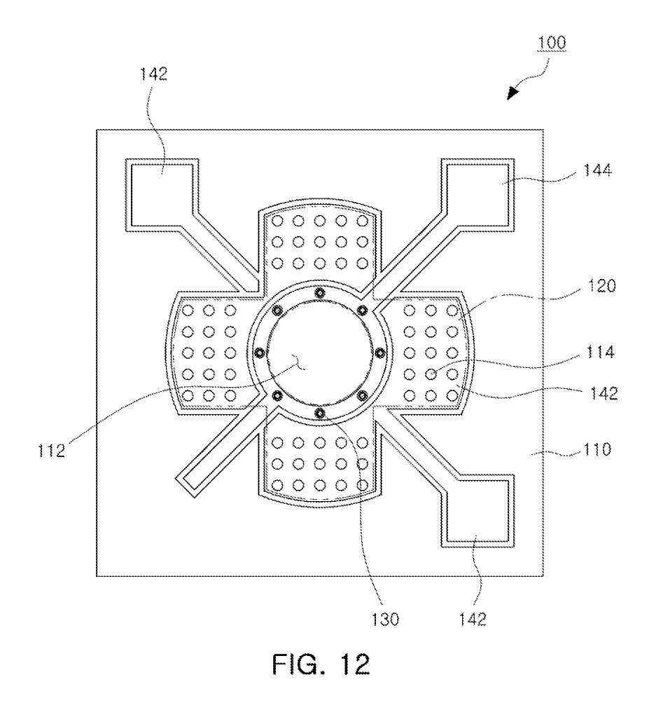

An acoustic transducer according to another exemplary embodiment in the present disclosure will be described with reference to FIGS. 11 and 12.

The acoustic transducer 100 according to the present exemplary embodiment may be distinguished from the acoustic transducer 100 according to exemplary embodiments as described above in a plan shape of the vibration member 120. For example, the vibration member 120 may be formed in a cross shape as shown in FIG. 11.

The substrate member 110 may be provided with the first electrode 142 having a shape substantially equal or similar to that of the vibration member 120. For example, the first electrode 142 may be formed in the cross shape, similar to the vibration member 120. However, the shape of the first electrode 142 is not limited to the above-mentioned shape. For example, the first electrode 142 may be formed in a quadrangular shape, which is larger than the vibration member 120.

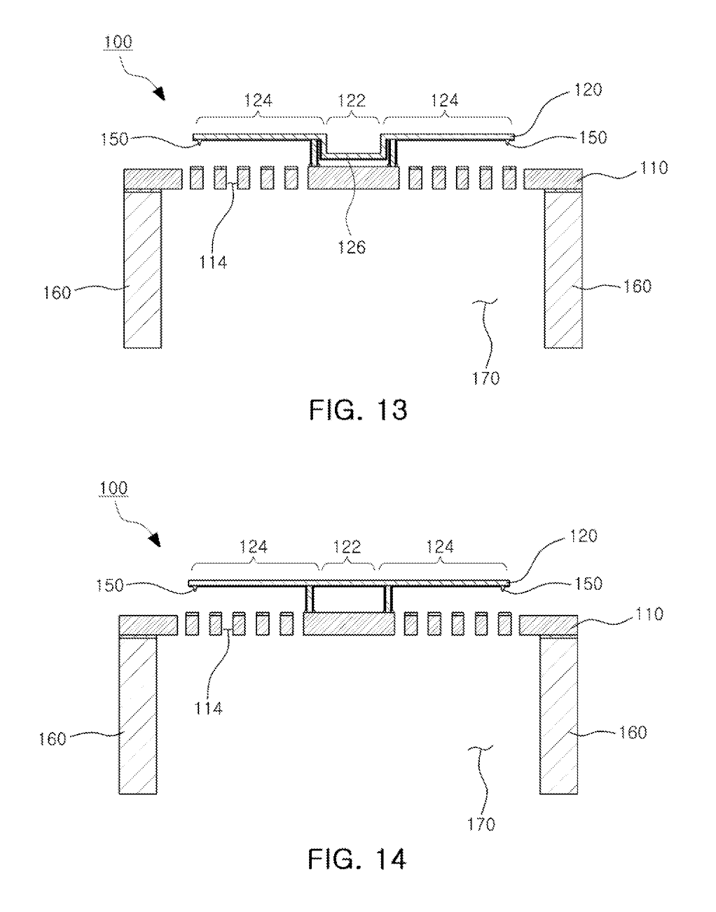

An acoustic transducer according to another exemplary embodiment in the present disclosure will be described with reference to FIGS. 13 and 14.

The acoustic transducer 110 shown in FIG. 13 may be distinguished from the acoustic transducer 110 according to exemplary embodiments as described above in the shape of the substrate member 110. For example, the substrate member 110 may have a plurality of second holes 114 formed therein. The above-mentioned structure may move most sound waves to the second region 124 of the vibration member 120.

The acoustic transducer 110 shown in FIG. 14 may be distinguished from the acoustic transducer 110 according to exemplary embodiments as described above in the shape of the substrate member 110 and the vibration member 120. For example, the configuration of the first hole may be omitted from the substrate member 110 and the configuration of the protrusion part may be omitted from the vibration member 120. The above-mentioned structure may reduce the size of the first region 122 in the vibration member 120.

As set forth above, according to exemplary embodiments of the present disclosure, the acoustic sensitivity may be efficiently improved without increasing the size of the vibration member.

While exemplary embodiments have been shown and described above, it will be apparent to those skilled in the art that modifications and variations could be made without departing from the scope of the present invention as defined by the appended claims.

What is claimed is:

1. An acoustic transducer comprising:
a substrate member provided with a plurality of holes formed therein through which sound waves are input;
a vibration member including a first region and a second region provided at an edge of the first region, and disposed to be parallel to the substrate member while having an interval between the vibration member and the substrate member; and
a plurality of support members disposed along the edge of the first region.

2. The acoustic transducer of claim 1, wherein the substrate member or the vibration member is provided with an insulating member configured to prevent electrical contact between the substrate member and the vibration member.

3. The acoustic transducer of claim 1, further comprising:
a first electrode formed on the substrate member; and
second electrodes formed on the vibration member and the support member.

4. The acoustic transducer of claim 1, wherein a distance between the first region and the substrate member is shorter than a distance between the second region and the substrate member.

5. The acoustic transducer of claim 1, wherein the vibration member is provided with a plurality of grooves formed therein and extended in a radial direction based on the first region.

6. The acoustic transducer of claim 1, wherein the vibration member is formed to have a polygonal shape or a cross shape.

7. An acoustic transducer comprising:
a substrate member having a first hole formed to transfer sound waves input from one side to the other side and a plurality of second holes disposed to be spaced apart from one another, based on the first hole;
a vibration member disposed to be parallel to the substrate member while having an interval between the substrate member and the vibration member; and
a plurality of support members disposed along an edge of the first hole.

8. The acoustic transducer of claim 7, wherein the substrate member or the vibration member is provided with an insulating member configured to prevent electrical contact between the substrate member and the vibration member.

9. The acoustic transducer of claim 7, wherein the vibration member includes a protrusion part protruding in a direction toward the first hole.

10. The acoustic transducer of claim 9, wherein the protrusion part has a diameter larger than a diameter of the first hole so that the sound waves input through the first hole are dispersed toward an edge of the vibration member.
